(19) United States
(12) Patent Application Publication
(10) Pub. No.: US 2006/0200317 A1
(43) Pub. Date: Sep. 7, 2006

(54) Instructional device

(76) Inventor: Michael Otto, Richfield, MN (US)

Correspondence Address: Mark A. Litman & Associates, P.A.;York Business Center, Suite 205, 3209 West 76th St., Edina, MN, 55435, US

(21) Appl. No.: 11/071,094

(22) Filed: Mar. 3, 2005

(51) Int. Cl. G06F 19/00

(52) U.S. Cl. 702/20

(57) ABSTRACT

A model displays events that may occur with a chromosome by providing two segments that are separable and recombinable, each segment representing one half of a chromosome and the two segments representing a complete chromosome, the model being capable of supporting itself on a vertical surface. The model may have an area wherein chromatid identification can be varied at two ends of each segment without writing on the two ends of the segment.

### BACKGROUND OF THE INVENTION

1. Field of the Invention

The present invention relates to instructional devices, teaching tools, and displays for use in providing instruction, particularly within a classroom teaching environment. The invention relates to the field of display tools that can assist in the explanation and display of biological events.

2. Background of the Art

It is common to use instructional devices in the class room. Cork boards, chalk boards, pin-up boards, poster boards, and other display devices have been used in class rooms to assist teachers in providing observational means for assisting in the understanding and appreciation of class room subjects. It is well understood that the use of instructional tools and models can be of great assistance in passing on an understanding of complex events and structures. It is understood that hands on observation can lead to a more rapid and more thorough understanding of the subject.

In the area of biology, the nature of the subject has changed dramatically over the years. Because of the advances in technology, the complexity of the subject and the need for appreciation of the chemistry and physics involved in the subject has increased dramatically. It is common for Middle School and High School projects to include construction of models of chromosomes, RNA and DNA molecules, which would have been Nobel Prize winning technology merely 50 years ago. Numerous kits are available in stores for construction of DNA molecules, but even these kits can be complex, and can require such significant periods of time to construct the models that an entire class could not share in the benefits of the model construction in normal class room time. It is desirable for an instructor to have tools that can be readily used, easily understood, and shared or used or observed by small numbers of students without great expense.

### SUMMARY OF THE INVENTION

A model shows chromosomes, and the model enables display of chromosome activity during mitosis, potential display of chromatids, and crossover events during recombination. The model comprises at least two pieces that may be attached and detached at specific locations to show splitting of chromosomes, and may have identifiable portions that can indicate chromatids and display chromatid exchange (the crossover effect) during genetic recombination. The model may be supportable on another medium (e.g., magnetic attachment to a metal surface, respositionable adhesive to a board, pins or tacks to a soft surface, etc.) and the attaching/detaching system can be repeated without significant damage to the model.

### BRIEF DESCRIPTION OF THE FIGURE

FIG. 1 shows a vertical view of one embodiment of a display model of a chromosome according to teachings provided herein.

### DETAILED DESCRIPTION OF THE INVENTION

There are 75 trillion (7,500,000 billion) nearly identical cells in the human body. Within each cell there is a nucleus (center) that is made up of 46 chromosones. These chromosones are inherited (−22 from your mother and 22 from your father). The final two chromosones are sex chromosones, and males have an X and Y and females have two X's. Chromosones contain within them equal parts of DNA and protein.

In the process of cell regeneration, a process known as mitosis occurs in which the cell (and internal components thereof) splits and attempts to essentially identically reproduce itself. This process also occurs in meiosis, a type of cell regeneration responsible for the production of gametes (sperm and egg). The splitting and reproduction of chromosomes are part of the process. There are a number of subtle events that can occur during the process of mitosis and meiosis, especially with respect to the activity of chromosomes that need to be understood to appreciate factors affecting genetic variation. These events can be drawn on a blackboard, printed onto sheets and the like, but these techniques may not convey all of the intricacies of the vents, and for different levels of classes or students, individual and distinct instructions and support may be needed.

A model of at least one chromosome is provided that can be used by at least one and possibly multiple instructional levels, with minimum wear and an extended life to the model.

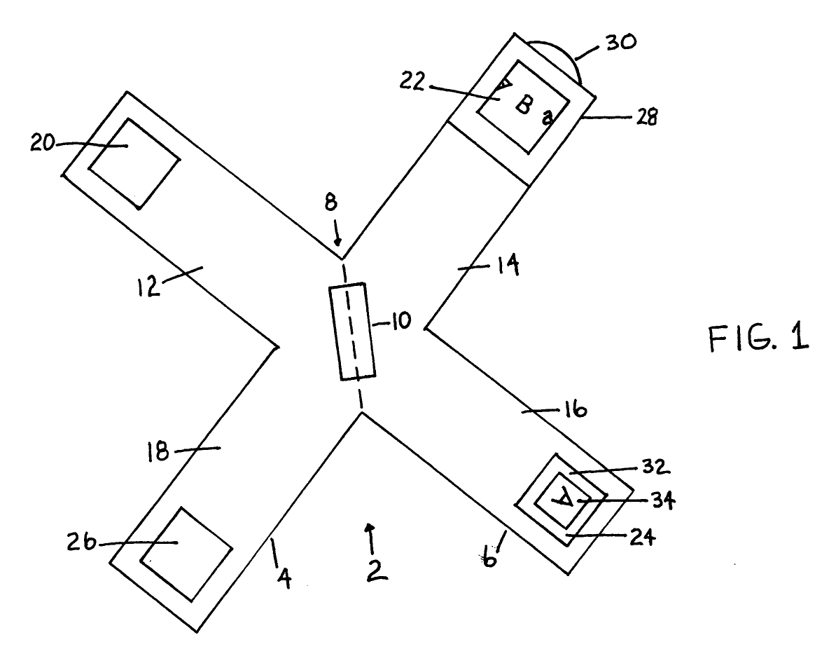

Review of FIG. 1 will assist in an understanding of this device. The device 2 is shown with two distinct portions 4 and 6, which can be separated to indicate a step in mitosis and recombination. The distinct portions 4 and 6 separate along line 8. The two distinct portions 4 and 6 may be temporarily and separably secured by an optional locking mechanism 10 which might be a hook-and-loop (e.g., Velcro™) connector, an eye and hook attachment, clips, slot and tooth, adhesive, snaps, engaging elements, magnets or other engaging elements. The two portions 4 and 6 are separated without breaking the device. There are four arms 12, 14, 16 and 18 on the chromosome, and as another optional element, four chromatid identification areas 20, 22, 24 and 26 may be provided. These chromatid identification areas may be left blank, or chromatid identification (e.g., A, B, C, a, b and c) may be present permanently or replaceably on the four chromatid identification areas 20, 22, 24 and 26. The chromatid identification may be replaceable by having a wheel 30 that rotates to expose different identifications, by having one half 32 of a hook-and-loop fastening system on an arm 16, with a second half 34 of a hook-and-loop fastening system carrying the identification that may be positioned on the arm 16, by static or surface tension clinging attachments, a sleeve that slides over an arm, or by a simple repositionable adhesive or pressure sensitive adhesive.

The use of the chromatid identifier may be useful during more advanced instruction of events occurring during meiosis where there may be crossover effects that occur during recombination. By having the chromatid identification variable, exchanges, differences between homologous chromosomes, and the like can be readily indicated without artificial marking or writing upon the model.

The structure of the model may be made of appropriately sturdy materials. Typically a self sustaining or flexible material such as wood, metal, rubber, plastic, elastomer, stiff paper, card board, particle board or composite may be used. When the model is to be supported on a display surface, a back side of the model may have a magnetic element (to secure it to a metal surface such as a white board, which has a metal under structure), a hook-and-loop fastener, clips, pins, adhesive (pressure-sensitive or repositionable), snaps, and the like. The mechanism for securing the structure to the surface does not have to uniformly cover the backside of the model, but may cover a sufficient area to provide minimal or essential securement. For example, the backside of each half of the model may have at least a single magnet (e.g., ⅛ inch or more) on it, at least a single adhesive patch (e.g., two-sided adhesive tape) or other adhering system for the vertical surface on which the model is to be displayed. Depending upon the weight of the front side material of the model, this would be sufficient to support the model half on the surface.

Other decorative or instructive effects may be provided on the models such as sleeves of loose fabric that can represent centromeres, and the like. Different colors may be used on the different arms or segments 4 and 6.

The model can be used by supporting the model in front of an entire class, and/or by handing out models to individual students or groups of students. The instructor can manipulate a first model (which may be the same size of larger than the student models) and the students can replicate the movement of the segments at their seats for a more intimate review of the process. The cross-over effect can be more readily observed, and where the chromatid identification is removable (as by an end piece 28 being removable and insertable), actual exchanges of chromatids can be effected to show the variations. This can assist in physically displaying the effects of variations, the number of possible variations, and the potential for recessive and dominant gene effects.

Although specific examples and materials have been provided for this discussion, the disclosure is not intended to be limiting by these specific examples, but rather the examples are species within a generic disclosure.

What is claimed:

1. A model for display of events that may occur with a chromosome comprising two segments that are separable and recombinable, each segment representing one half of a chromosome and the two segments representing a complete chromosome, the model being capable of supporting itself on a vertical surface.

2. The model of claim 1 wherein the model having an area wherein chromatid identification can be varied at two ends of each segment without writing on the two ends of the segment.

3. The model of claim 1 wherein the model has a magnetic material on a backside of the model to assist in supporting the model on a metallic surface that comprises the vertical surface.

4. The model of claim 1 wherein the model has an adhesive material on a backside of the model to assist in supporting the model on the vertical surface.

5. The model of claim 2 wherein chromatid identification can be varied on a hook-and-loop surface.

6. The model of claim 2 wherein chromatid identification can be varied on an adhesive surface on an end of a segment.

7. The model of claim 2 wherein chromatid identification can be varied on an end of a segment by rotating a display under a window.

8. A model for display of events that may occur with a chromosome comprising two segments that are separable and recombinable, each segment representing one half of a chromosome and the two segments representing a complete chromosome, the model having an area wherein chromatid identification can be varied at two ends of each segment without writing on the two ends of the segment.

9. The model of claim 8 wherein the model has a magnetic material on a backside of the model to assist in supporting the model on a metallic surface that comprises the vertical surface.

10. The model of claim 8 wherein the model has an adhesive material on a backside of the model to assist in supporting the model on the vertical surface.

11. The model of claim 8 wherein chromatid identification can be varied on a hook-and-loop surface.

12. The model of claim 8 wherein chromatid identification can be varied on an adhesive surface on an end of a segment.

13. The model of claim 8 wherein chromatid identification can be varied on an end of a segment by rotating a display under a window.
